(19) United States
(12) Patent Application Publication
(10) Pub. No.: US 2018/0222284 A1
(43) Pub. Date: Aug. 9, 2018

(54) METHOD OF MITIGATING TEMPERATURE BUILDUP IN A PASSENGER COMPARTMENT

(71) Applicant: FORD GLOBAL TECHNOLOGIES, LLC, Dearborn, MI (US)

(72) Inventors: Brian Joseph Robert, Saint Clair Shores, MI (US); Kent Snyder, Dearborn, MI (US)

(21) Appl. No.: 15/428,668

(22) Filed: Feb. 9, 2017

(51) Int. Cl. B60H 1/00; B60H 1/24

(52) U.S. Cl. CPC B60H 1/00778; B60H 1/00792; B60H 2001/00928; B60H 1/241; B60H 1/00821

(57) ABSTRACT

A method of mitigating temperature buildup in a passenger compartment of a vehicle is provided. The method includes the steps of: (a) monitoring a temperature differential between a temperature inside the passenger compartment and an ambient temperature of the passenger compartment; (b) generating power utilizing the temperature differential; and (c) actuating a passive mitigation accessory when the temperature differential is above a predetermined threshold. The method may include the additional steps of using the power generated utilizing the temperature differential to actuate said passive mitigation accessory and/or providing the power generated utilizing the temperature differential to said passive mitigation accessory via at least one standard wire harness of the vehicle.

### TECHNICAL FIELD

This document relates generally to vehicle cabin climate control, and more specifically to a method of mitigating temperature buildup in a passenger compartment of a vehicle.

### BACKGROUND

It is well known that vehicle passenger compartments can become uncomfortably warm in the absence of active passenger compartment climate controls. This is the case whether the vehicle is parked or in operation. Parked vehicle thermal accumulation within the passenger compartment has been demonstrated to increase cabin temperatures to more than 20° C. above an ambient temperature, which is often uncomfortable for passengers. Like conventional vehicles, electric vehicles require climate control to maintain occupant comfort and safety, but cabin heating and air conditioning have a negative impact on driving range for all-electric vehicles. In other words, utilization of the climate controls creates a burdensome electrical demand for the vehicle.

As vehicle electrification becomes more common place and the integration of electronic equipment within the vehicle increases, there is a growing effort to increase the system's electrical efficiency, reduce losses, and reclaim energy. While competitors attempt to add solar options for climate mitigation, the size, weight, and efficiency remain wanting with few customers selecting the high-cost vehicle option. The noted temperature differential from passenger compartment to ambient and the established desire to remedy customer discomfort provides an opportunity for passive and active solutions to be deployed.

Accordingly, a need exists for mitigating temperature buildup in a passenger compartment of a vehicle. One proposed solution leverages the growing maturity of thermoelectric devices based on an inherent ability for thermal gradient electricity generation. From the noted +20° C. cabin-to-ambient temperature differential, a scaled thermoelectric device, or thermoelectric generator (TEG), can effectively reclaim nominal electrical power for vehicle auxiliary systems. Such auxiliary systems may be utilized for passive and/or active passenger compartment climate normalization or temperature mitigation.

Importantly, the utilization of thermoelectric devices at perspective locations in the vehicle exploit the noted cabin-to-ambient temperature differential while being in thermal communication with both regions. Such devices may utilize standard, or existing, electrical wire harnesses thereby minimizing system changes and enabling design/integration structures. This provides the designer and manufacturer with a considerable advantage over solar-based solutions. Even more, the devices may be utilized for harvesting electric power, including supplemental battery charging (12V/48V) in addition to passive and active passenger compartment climate normalization. Last, thermoelectric devices offer several advantages over other technologies, including, a lack of moving parts thus lowering maintenance requirements, a life expectancy of greater than 100,000 hours of steady-state operation, an ability to function in severe environments and tight locations, and are not position or orientation dependent.

### SUMMARY OF THE INVENTION

In accordance with the purposes and benefits described herein, a method is provided of mitigating temperature buildup in a passenger compartment of a vehicle. The method may be broadly described as comprising the steps of: monitoring a temperature differential between a temperature inside the passenger compartment and an ambient temperature of the passenger compartment; generating power utilizing the temperature differential; and actuating a passive mitigation accessory when the temperature differential is above a predetermined threshold.

In another possible embodiment, the method further includes the step of using the power generated utilizing the temperature differential to actuate said passive mitigation accessory.

In yet another possible embodiment, the method further includes the step of providing the power generated utilizing the temperature differential to said passive mitigation accessory via at least one standard wire harness of the vehicle.

In still another possible embodiment, the method further includes the step of actuating an active mitigation accessory when the temperature differential is above the predetermined threshold. In another possible embodiment, the step of actuating the active mitigation accessory when the temperature differential is above the predetermined threshold occurs at a predetermined time after the step of actuating the passive mitigation accessory if the temperature differential remains above the predetermined threshold at the predetermined time.

In one other possible embodiment, the step of actuating the active mitigation accessory when the temperature differential is above the predetermined threshold occurs after the step of actuating the passive mitigation accessory if the temperature differential increases over time.

In yet still another possible embodiment, the method further includes the step of deactivating said passive mitigation accessory if the temperature differential falls below the predetermined threshold.

In still an additional possible embodiment, the step of actuating said passive mitigation accessory when the temperature differential is above the predetermined threshold includes moving said passive mitigation accessory from a first position to a second position, and the step of deactivating said passive mitigation accessory if the temperature differential falls below the predetermined threshold includes moving said passive mitigation accessory from the second position to the first position.

In another possible embodiment, the method further includes the step of actuating an active mitigation accessory when the temperature differential is above the predetermined threshold.

In still another possible embodiment, the method further includes the step of charging a battery of the vehicle using the power generated utilizing the temperature differential.

Another possible method of mitigating temperature buildup in a passenger compartment of a vehicle may be broadly described as comprising the steps of: monitoring a temperature differential between a temperature inside the passenger compartment and an ambient temperature of the passenger compartment; generating power utilizing the temperature differential; and utilizing the power generated utilizing the temperature differential to actuate a passive mitigation accessory when the temperature differential is above a predetermined threshold and an active mitigation accessory when the temperature differential remains at or above the predetermined threshold a period of time after actuation of said passive mitigation device.

In still another possible embodiment, the step of monitoring a temperature differential includes monitoring an intensity of the power generated utilizing the temperature differential. In other words, the intensity of the power generated utilizing the temperature differential is indicative of the temperature differential itself.

In another possible embodiment, the method further includes the step of charging a battery of the vehicle using the power generated utilizing the temperature differential.

In yet another possible embodiment, the method further includes the step of providing the power generated utilizing the temperature differential to at least one of said passive mitigation accessory and said active mitigation accessory via at least one standard wire harness of the vehicle.

Another possible method of mitigating temperature buildup in a passenger compartment of a vehicle may be broadly described as comprising the steps of: generating power utilizing a temperature differential between a temperature inside the passenger compartment and an ambient temperature of the passenger compartment; and utilizing the generated power to actuate at least one active mitigation accessory.

In still another possible embodiment, a circuit for mitigating temperature buildup in a passenger compartment of a vehicle may be broadly described as comprising at least one temperature sensor for sensing a temperature inside the passenger compartment and an ambient temperature of the passenger compartment, a thermoelectric device for generating power utilizing a temperature differential between the temperature inside the passenger compartment and the ambient temperature of the passenger compartment, and a control module for receiving an output of said at least one temperature sensor indicative of the temperature differential and actuating a passive mitigation accessory when the temperature differential is above a predetermined threshold.

In another possible embodiment, the control module actuates an active mitigation accessory a period of time after actuating said passive mitigation accessory.

In yet another possible embodiment, the control module actuates said active mitigation accessory a predetermined time after actuating said passive mitigation accessory if the temperature differential remains above the predetermined threshold at the predetermined time.

In still another possible embodiment, the thermoelectric device is connected to said control module, said passive mitigation accessory, and said active mitigation accessory utilizing at least one standard wiring harness of the vehicle.

In one other possible embodiment, the passive mitigation accessory is at least one glass panel, and said active mitigation accessory is at least one motor for driving at least one fan.

In other possible embodiments, the circuits for mitigating temperature buildup in a passenger compartment described above are incorporated into a vehicle.

In the following description, there are shown and described several embodiments of a method of mitigating temperature buildup in a passenger compartment of a vehicle and a related circuit. As it should be realized, the methods and systems are capable of other, different embodiments and their several details are capable of modification in various, obvious aspects all without departing from the methods and assemblies as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the vehicle, circuits, and methods and together with the description serve to explain certain principles thereof. In the drawing figures:

FIG. 1 is an exemplary illustration of a vehicle in perspective view;

FIG. 2 is a is a block diagram of an exemplary circuit for mitigating temperature buildup in a passenger compartment of a vehicle;

FIG. 3 is a flow chart schematic for mitigating temperature buildup in a passenger compartment of a vehicle; and

FIG. 4 is a block diagram of an exemplary circuit for mitigating temperature buildup in a passenger compartment of a vehicle.

Reference will now be made in detail to the present preferred embodiments of the method of mitigating temperature buildup in a passenger compartment of a vehicle and related circuits, examples of which are illustrated in the accompanying drawing figures, wherein like numerals are used to represent like elements.

### DETAILED DESCRIPTION

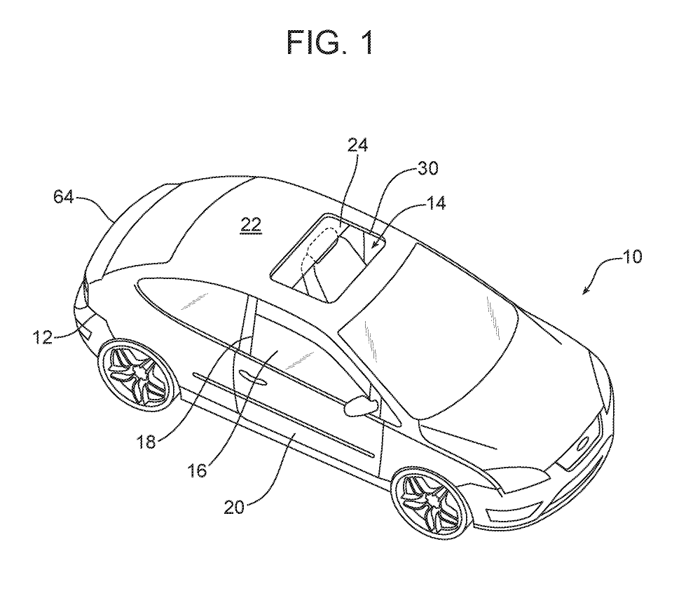

As shown in FIG. 1, an automotive passenger vehicle 10 is generally illustrated as a vehicle having a body 12 and a passenger compartment 14. Various movable closure members (e.g., powered window assemblies) provide an opening between the passenger compartment 14 and ambient air surrounding the passenger compartment or vehicle 10. The powered window assemblies include, for example, a window 16 (shown partially open) that moves between open and closed positions within an opening 18 in the side door 20 of the vehicle 10.

Additionally, the vehicle 10 has a powered moonroof assembly located in the roof 22 of the vehicle body 12. The moonroof assembly includes a movable closure member 24 (shown partially open), such as a transparent glass window, which is commonly referred to as a moonroof. A sunroof is a retractable roof panel often made of the same material as the body of the vehicle that lets light or air into a vehicle. Sunroofs that are glass, or are otherwise see through or translucent, are typically referred to as moonroofs. For purposes of this invention, moonroofs are considered to be a subset of sunroofs. Regardless, all such movable closure members of the vehicle 10 are passive mitigation accessories which support the mitigation of temperature buildup in the passenger compartment 14 when opened.

As should be evident to those skilled in the art, the moonroof 24 may be actuated responsive to a user switch 26 and may include an actuator to move the moonroof 24 between an open position and a closed position. The moonroof 24 is actuated by a motor 28 to move fore and aft between the open position and the closed position with respect to an opening 30 in the roof 22. Each of these passive mitigation accessories of the vehicle 10, which are also be referred to as movable closure members, are similarly configured. For example, the window 16 may be actuated in response to a user switch 32 and may include an actuator, such as a motor 34, to move the window 16 between an open position and a closed position. The window 16 is actuated by the motor 34 to move up and down between the closed position and the open position with respect to the opening 18 in the side door 20.

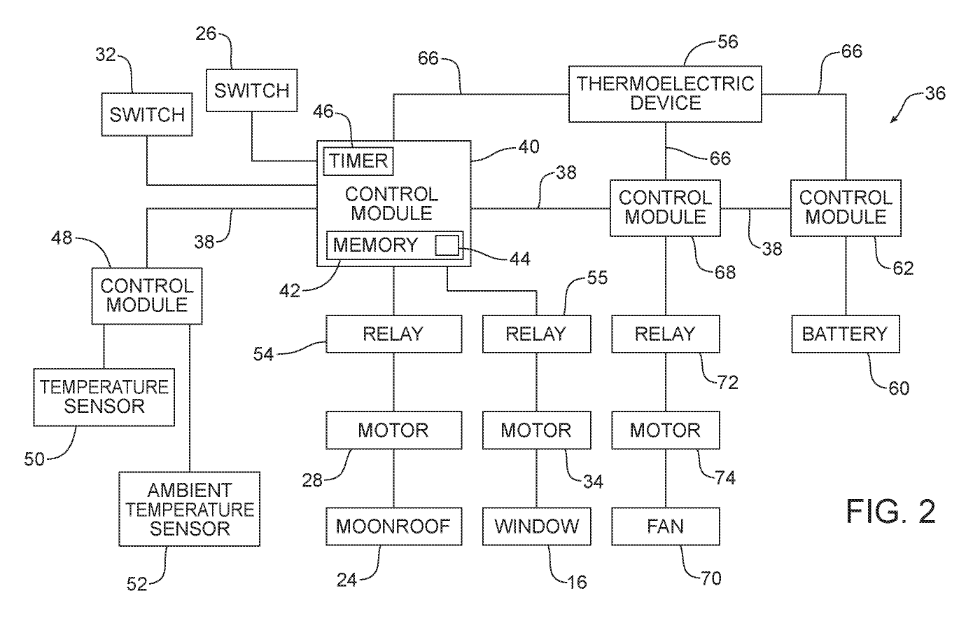

FIG. 2 illustrates a schematic diagram of an exemplary circuit 36 for mitigating temperature buildup in a passenger compartment of a vehicle. The circuit 36 includes a plurality of control modules interconnected by a communications network 38. The communications network 38 may be a controller area network (CAN) bus or a local interconnect network (LIN) bus, as is known in the art. As shown, a first control module 40 includes a memory 42 that stores a control program 44 run by the control module, and an internal timer 46.

The timer 46 is utilized to determine elapsed times, among other tasks, as will be described in more detail below. Such elapsed times and/or predetermined periods of time described herein are configurable and may be changed during the manufacturing process, or in possible alternate embodiments by the vehicle owner. In the described embodiment, the first control module 40 is a body control module which controls and monitors an “OPEN” or a “CLOSED” state of one or more passive mitigation accessories of the vehicle 10.

The body control module 40 continuously monitors and receives inputs concerning various conditions associated with the vehicle 10. The inputs may be received directly from a user switch, a sensor (e.g., a temperature or thermal sensor, a load sensor or the like) as described below, or via other control modules within the vehicle 10 via the communications network 38. Dependent upon those inputs, the body control module 40 may initiate certain actions including, for example, opening the moonroof 24 under certain circumstances.

In the described embodiment, the circuit 36 further includes a second control module 48 for monitoring a temperature sensor 50 positioned to determine a temperature inside the passenger compartment 14 and an ambient temperature sensor 52 positioned to determine an ambient temperature of the passenger compartment. In other words, the temperature sensor 50 provides an output indicative of a temperature inside the passenger compartment 14 and the ambient temperature sensor 52 provides an output indicative of a temperature outside of the passenger compartment or outside of the vehicle 10 to the second control module 48.

Outputs of the temperature sensor 50 and the ambient temperature sensor 52, or a temperature differential between the two, are communicated from the second control module 42 to the first control module 40 via the communications network 38. The first control module 40, in the described embodiment, monitors the temperature differential. When the first control module 40 determines that the temperature differential is above a predetermined threshold, the first control module actuates a passive mitigation accessory, such as, the moonroof 24, the window 16, and/or other passive mitigation accessories. In the described embodiment, the predetermined threshold is 20° C. above the ambient temperature. Of course, different threshold temperatures may be utilized in accordance with the invention.

Actuation includes moving the passive mitigation accessory from a first position to a second position. Typically, this would be from a closed position to an open position but arguably circumstances could exist where it would be desirable to move the passive mitigation accessory from a partially open position to a fully open position or from an open to a closed position. In the event of precipitation, for example, a precipitation sensor may be monitored by the control module which may prevent actuation of the passive mitigation accessory or may move the passive mitigation accessory from an open to a closed position. The control module may further actuate an active mitigation accessory in place of the actuation of the passive mitigation accessory when the precipitation sensor senses a precipitation event.

As further shown in FIG. 2, the first control module 40 actuates a passive mitigation accessory (e.g., the moonroof 24) via a relay 54. The relay 54 switches power from a thermoelectric device 56 via the first control module 40 to the motor 28. Similarly, the first control module 40 may actuate the window 16 or other passive mitigation accessory utilizing power from the thermoelectric device 56. In the case of the window 16, relay 55 switches power from the thermoelectric device 56 via the first control module 40 to the motor 34. As noted above, one or more passive mitigation accessories may be utilized in series or concurrently in accordance with the invention.

A first passive mitigation accessory, for example, may be actuated once the temperature differential is above the predetermined threshold. If the temperature differential remains above the predetermined threshold at a predetermined time, a second passive mitigation accessory is activated. Of course, alternate embodiments may have the first and second passive mitigation accessories actuated at the same time (e.g., when the temperature differential rises above the predetermined threshold.).

In the described embodiment, the thermoelectric device 56 also provides power for charging a battery 60, which is a supplemental battery (e.g., a 12 volt or 48 volt battery), via a third control module 62. Thermoelectric devices, such as the one used in the described embodiment, generate electricity or power utilizing a difference of temperatures. In this instance, the difference of temperatures is between the temperature in the passenger compartment 14 and the ambient temperature outside of the passenger compartment.

More specifically, the thermoelectric device 56 is a thermoelectric generator which is known in the art and works on the basis of the Seebeck effect. The device is an integrated thermoelectric generator having N-type and P-type semiconductor pellets soldered between substrates (e.g., ceramic insulators) that are electrically in series and thermally in parallel. In operation, a first substrate is in thermal communication with the ambient environment outside of the passenger compartment 14 and a second substrate is in thermal communication with the environment inside of the passenger compartment. When a sufficient temperature differential or gradient is applied across the thermoelectric device 56, an electric potential is generated which can be used a source of electrical power via positive and negative leads.

In the described embodiment, the thermoelectric device 56 may include a plurality of thermoelectric devices or one or more devices may be sized to provide sufficient power. Such device(s) may be integrated in vehicle doors (e.g., door 20), roofs (e.g., roof 22), rear-view consoles (e.g., console 64) and other locations within the vehicle 10 that allow for the device(s) to be in thermal communication with both the ambient environment outside of the passenger compartment 14 and the environment inside of the passenger compartment.

Also in the described embodiment, the thermoelectric device 56 may be connected via one or more control modules to a passive mitigation accessory, an active mitigation accessory, and/or a supplemental battery utilizing one or more standard wiring harnesses 66. In this instance, a standard wiring harness is defined as an original equipment manufactured wiring harness, i.e., a wiring harness that was originally designed for the vehicle but not designed to accommodate thermoelectric devices. In other words, the present invention can simply utilize existing wiring harnesses within the vehicle. Of course, unique wiring harnesses may likewise be added to a vehicle to support the mitigation efforts.

As eluded to above and in addition to the utilization of passive mitigation accessories to support the mitigation of temperature buildup in the passenger compartment 14, active mitigation accessories may likewise be utilized. As shown in FIG. 2, a fourth control module 68 actuates an active mitigation accessory (e.g., a fan 70) via a relay 72 that switches or provides power from the thermoelectric device 56 via the fourth control module to a motor 74. In the described embodiment, actuation of the active mitigation accessory occurs when the temperature differential is above the predetermined threshold. More specifically, actuation of the active mitigation accessory occurs a predetermined time after the step of actuating the passive mitigation accessory if the temperature differential remains above the predetermined threshold at the predetermined time. Of course, alternate embodiments may have the active and passive mitigation accessories actuated concurrently (e.g., when the temperature differential rises above the predetermined threshold.).

Alternatively, the step of actuating the active mitigation accessory when the temperature differential is above the predetermined threshold may occur after the step of actuating the passive mitigation accessory if the temperature differential increases or remains the same. In further embodiments, however, activation of both the passive and active mitigation accessories may occur after a predetermined time after the temperature differential reaches the predetermined threshold. In another embodiment, the step of actuating the active mitigation accessory may occur a predetermined time after a last in a series of one or more actuations of passive mitigation accessories if the temperature differential increases or remains above the temperature threshold.

Once the temperature differential falls below the predetermined threshold, whether a certain percentage below, or a certain number of degrees below, or upon reaching a predetermined temperature (e.g., the predetermined threshold temperature or a temperature below the predetermined threshold temperature), one or more of the control modules deactivate the active and passive mitigation accessories. This may occur concurrently or otherwise. In the described embodiment, relay 72 is actuated to remove power to motor 74 thereby turning fan 70 off. Similarly, the passive mitigation accessories are moved from the second position to the first position wherein the first position could be fully closed or partially closed.

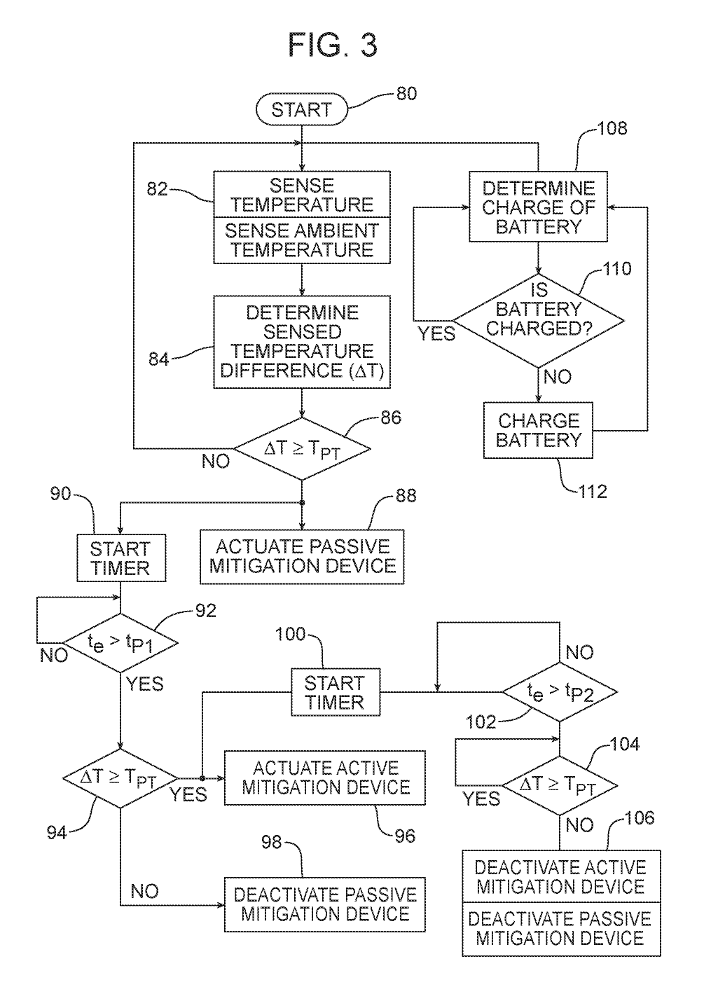

The steps utilized in the described embodiment will be described with reference to FIG. 3. FIG. 3 is a flowchart of operational control of the control system of the vehicle 10 according to the described embodiment. The processing sequence related to operational control, according to the described embodiment, is executed by a processor of the body control module 40 communicating via a communications network 38 as the control program 44 stored in memory 42. Upon initiation of the sequence at Step 80, a temperature of the passenger compartment 14 and an ambient temperature outside of the passenger compartment are sensed by sensors 50 and 52 at Step 82. A differential in temperature between the two sensed temperatures is determined and monitored at Step 84. If the differential in temperature (ΔT) between the two sensed temperatures is determined to be greater than or equal to a predetermined threshold (T_{PT}) (e.g., 20° C. above the sensed ambient temperature) at Step 86, then a passive mitigation accessory is actuated at step 88. If the differential in temperature remains below 20° C., then temperatures are sensed at Step 82 and a differential in temperature is again determined at Step 84.

When the passive mitigation accessory is actuated at Step 88, a timer 46 is concurrently initialized setting an elapsed time to zero (e.g., tₑ=0) at Step 90. At the end of a first predetermined period of time (t_{P1}) as determined at Step 92, the differential in temperature (ΔT) is again compared to the predetermined threshold (T_{PT}) at Step 94. If the differential in temperature (ΔT) remains above the predetermined threshold (T_{PT}) at the first predetermined time period (t_{P1}), an active mitigation accessory is activated at Step 96. If, on the other hand, the differential in temperature (ΔT) falls below the predetermined threshold (T_{PT}) at the predetermined time period (t_{P}), then the passive mitigation accessory is deactivated at Step 98 and there is no need for the active mitigation accessory to be activated.

When the active mitigation accessory is actuated at Step 96, the timer 46 is concurrently reinitialized setting tₑ=0 at Step 100. At the end of a second predetermined period of time (t_{P2}) as determined at Step 102, the differential in temperature (ΔT) is again compared to the predetermined threshold (T_{PT}) at Step 104. If the differential in temperature (ΔT) remains above the predetermined threshold (T_{P}) at second predetermined period of time (t_{P2}), the sequence loops back to Step 104 until the differential in temperature (ΔT) falls below the predetermined threshold (T_{PT}). Once the differential in temperature (ΔT) falls below the predetermined threshold (T_{PT}), the active and passive mitigation accessories are deactivated at Step 106.

Concurrently with the above steps, the processing sequence related to operational control determines the charge of the supplemental battery 60 at Step 108. If the batter is sufficiently charged as determined at Step 110, then the sequence loops back to Step 108 and the charge of the supplemental battery 60 is again determined. Once the charge of the supplemental battery 60 is determined at Step 110 to be below a sufficient level, the battery is charged at Step 112 with power from the thermoelectric device 56 as described above. Charging continues until the supplemental battery 60 is determined to be sufficiently charged at Step 110.

In summary, numerous benefits result from the method of mitigating temperature buildup in a passenger compartment of a vehicle 10 as illustrated in this document. The method is capable of controlling active and passive mitigation accessories to control a temperature in the passenger compartment while limiting auxiliary loading on the vehicle's electrical system. Although the vehicle 10 in the described embodiment is an electric vehicle, the mitigation methods and related circuits are equally relevant to hybrid and conventional vehicles.

The foregoing has been presented for purposes of illustration and description. It is not intended to be exhaustive or to limit the embodiments to the precise form disclosed. Obvious modifications and variations are possible in light of the above teachings. For example, the temperature thresholds, periods of time, and predetermined periods of time can each be adjusted at the manufacturing stage or by the vehicle operator.

Even more, one alternate embodiment may, for example, utilize an intensity (e.g., watts) of a generated power from the thermoelectric device 56 as the condition associated with the vehicle 10 monitored by the body control module 40. This approach eliminates the need to sense temperatures in and ambient to the passenger compartment 14 and the need to determine a temperature differential. Rather, the body control module 40 may initiate certain actions including, for example, opening the moonroof 24 dependent upon the intensity of the generated power. If the intensity rises above a predetermined threshold, the body control module 40 may initiate a first action (e.g., actuating a passive mitigation accessory). If the intensity remains above the predetermined threshold at a predetermined period of time, the body control module may initiate a second action (e.g., actuating a second passive mitigation accessory and/or an active mitigation accessory).

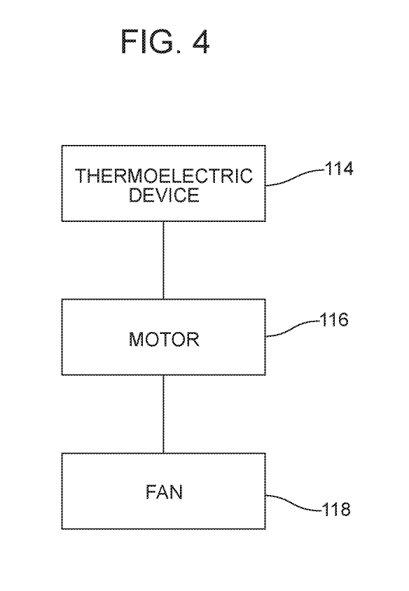

In a similar, yet even more rudimentary alternate embodiment, power generated utilizing by a thermoelectric device 114 utilizing the temperature differential between a temperature inside the passenger compartment and an ambient temperature of the passenger compartment may be utilized to actuate at least one active mitigation accessory. As shown in FIG. 4, for example, the thermoelectric device 114 is electrically connected directly to an active mitigation accessory, for example, a motor 116 for driving a fan 118. In such an embodiment, when the temperature differential between the temperature inside the passenger compartment and the ambient temperature of the passenger compartment is sufficient for the thermoelectric device 114 to generate power, the generated power is used to drive the active mitigation accessory.

Driving the fan pulls air into the passenger compartment forcing warmer air out of the passenger compartment through passive air extractor locations within the vehicle as is known in the art. Once the temperature differential subsides, whether due to the active mitigation accessory or otherwise, the thermoelectric device 114 will cease to generate power sufficient to actuate the active mitigation device. Of course, some additional circuitry may be required for regulating, converting, and/or limiting voltage or power to the motor 116 in some embodiments.

All such modifications and variations are within the scope of the appended claims when interpreted in accordance with the breadth to which they are fairly, legally and equitably entitled.

What is claimed:

1. A method of mitigating temperature buildup in a passenger compartment of a vehicle, comprising the steps of:
monitoring a temperature differential between a temperature inside the passenger compartment and an ambient temperature of the passenger compartment;
generating power utilizing the temperature differential; and
actuating a passive mitigation accessory when the temperature differential is above a predetermined threshold.

2. The method of mitigating temperature buildup in a passenger compartment of a vehicle of claim 1, further comprising the step of using the power generated utilizing the temperature differential to actuate said passive mitigation accessory.

3. The method of mitigating temperature buildup in a passenger compartment of a vehicle of claim 2, further comprising the step of providing the power generated utilizing the temperature differential to said passive mitigation accessory via at least one standard wire harness of the vehicle.

4. The method of mitigating temperature buildup in a passenger compartment of a vehicle of claim 1, further comprising the step of actuating an active mitigation accessory when the temperature differential is above the predetermined threshold.

5. The method of mitigating temperature buildup in a passenger compartment of a vehicle of claim 4, wherein the step of actuating the active mitigation accessory when the temperature differential is above the predetermined threshold occurs a predetermined time after the step of actuating the passive mitigation accessory if the temperature differential remains above the predetermined threshold at the predetermined time.

6. The method of mitigating temperature buildup in a passenger compartment of a vehicle of claim 4, wherein the step of actuating the active mitigation accessory when the temperature differential is above the predetermined threshold occurs after the step of actuating the passive mitigation accessory if the temperature differential increases over time.

7. The method of mitigating temperature buildup in a passenger compartment of a vehicle of claim 1, further comprising the step of deactivating said passive mitigation accessory if the temperature differential falls below the predetermined threshold.

8. The method of mitigating temperature buildup in a passenger compartment of a vehicle of claim 7, wherein the step of actuating said passive mitigation accessory when the temperature differential is above the predetermined threshold includes moving said passive mitigation accessory from a first position to a second position, and the step of deactivating said passive mitigation accessory if the temperature differential falls below the predetermined threshold includes moving said passive mitigation accessory from the second position to the first position.

9. The method of mitigating temperature buildup in a passenger compartment of a vehicle of claim 8, further comprising the step of actuating an active mitigation accessory when the temperature differential is above the predetermined threshold.

10. The method of mitigating temperature buildup in a passenger compartment of a vehicle of claim 1, further comprising the step of charging a battery of the vehicle using the power generated utilizing the temperature differential.

11. A method of mitigating temperature buildup in a passenger compartment of a vehicle, comprising the steps of:
monitoring a temperature differential between a temperature inside the passenger compartment and an ambient temperature of the passenger compartment;
generating power utilizing the temperature differential; and
utilizing the power generated utilizing the temperature differential to actuate a passive mitigation accessory when the temperature differential is above a predetermined threshold and an active mitigation accessory when the temperature differential remains at or above the predetermined threshold a period of time after actuation of said passive mitigation accessory.

12. The method of mitigating temperature buildup in a passenger compartment of a vehicle of claim 11, further comprising the step of providing the power generated utilizing the temperature differential to at least one of said passive mitigation accessory and said active mitigation accessory via at least one standard wire harness of the vehicle.

13. The method of mitigating temperature buildup in a passenger compartment of a vehicle of claim 11, wherein the step of monitoring a temperature differential includes monitoring an intensity of the power generated utilizing the temperature differential.

14. A method of mitigating temperature buildup in a passenger compartment of a vehicle, comprising the steps of:
generating power utilizing a temperature differential between a temperature inside the passenger compartment and an ambient temperature of the passenger compartment; and
utilizing the generated power to actuate at least one active mitigation accessory.

15. A circuit for mitigating temperature buildup in a passenger compartment of a vehicle comprising:
at least one temperature sensor for sensing a temperature inside the passenger compartment and an ambient temperature of the passenger compartment;
a thermoelectric device for generating power utilizing a temperature differential between the temperature inside the passenger compartment and the ambient temperature of the passenger compartment; and
a control module for receiving an output of said at least one temperature sensor indicative of the temperature differential and actuating a passive mitigation accessory when the temperature differential is above a predetermined threshold.

16. The circuit for mitigating temperature buildup in a passenger compartment of a vehicle of claim 15, wherein said control module actuates an active mitigation accessory a period of time after actuating said passive mitigation accessory.

17. The circuit for mitigating temperature buildup in a passenger compartment of a vehicle of claim 16, wherein said control module actuates said active mitigation accessory a predetermined time after actuating said passive mitigation accessory if the temperature differential remains above the predetermined threshold at the predetermined time.

18. The circuit for mitigating temperature buildup in a passenger compartment of a vehicle of claim 16, wherein said thermoelectric device is connected to said control module, said passive mitigation accessory, and said active mitigation accessory utilizing at least one standard wiring harness of the vehicle.

19. The circuit for mitigating temperature buildup in a passenger compartment of a vehicle of claim 16, wherein said passive mitigation accessory is at least one glass panel, and said active mitigation accessory is at least one motor for driving at least one fan.

20. A vehicle incorporating the circuit for mitigating temperature buildup in a passenger compartment of claim 15.
